(19) United States
(12) Patent Application Publication
(10) Pub. No.: US 2013/0028541 A1
(43) Pub. Date: Jan. 31, 2013

(54) PEELABLE STORAGE BAG AND METHOD OF MANUFACTURING

(71) Applicant: Charles Harder, Reno, NV (US)

(72) Inventor: Charles Harder, Reno, NV (US)

(21) Appl. No.: 13/362,699

(22) Filed: Jan. 31, 2012

Related U.S. Application Data
(60) Provisional application No. 61/437,913, filed on Jan. 31, 2011.

(51) Int. Cl. B65D 30/08; B31B 39/00

(52) U.S. Cl. 383/116; 493/210

(57) ABSTRACT

A storage bag for holding objects and materials is disclosed. The storage bag includes a pair of outer sheets and an inner sheet. The outer sheets are coupled by three seams. The storage bag has a cavity between the outer sheets and an opening. The inner sheet is mounted between portions of the outer sheets near the opening. The third sheet extends across the outer sheets between a pair of seams. The inner sheet has three layers that are coupled to each other. A first layer is coupled to one of the outer sheets by another seam and a third layer is adapted to be heat bonded to the other outer sheet. A weak bond area is formed between the third layer and the outer sheet. The weak bond allows the storage bag to be easily opened. A method of manufacturing the storage bag is also disclosed.

### CROSS REFERENCE TO RELATED APPLICATIONS

This application claims priority to U.S. provisional patent application Ser. No. 61/437,913 filed Jan. 31, 2011. The entire contents of which are herein incorporated by reference.

### FIELD OF THE INVENTION

The present invention relates to heat sealable storage bags that may be easily opened by a user.

### BACKGROUND

Storage bags are known in the art and many different types of storage bags have been developed. One type of storage bag is a heat sealable storage bag that uses heat to seal the bag. Once a user has placed objects or material in a bag, the user applies heat to seal the bag. One of the problems associated with this type of storage system is that the bags are difficult to open. Usually users must use cutting instruments, such as knives or scissors, to cut these bags open. Therefore, what has long been needed is a storage bag that is easy to open after it has been sealed.

### SUMMARY OF ONE EMBODIMENT OF THE INVENTION

### Advantages of One or More Embodiments of the Present Invention

The various embodiments of the present invention may, but do not necessarily, achieve one or more of the following advantages:

provide a storage bag that is easy to open after it has been sealed;

provide a storage bag that may be reused after it has been sealed and re-opened;

provide a storage bag that is inexpensive to manufacture;

provide a storage bag with a weak layer;

provide a storage bag that can be heat sealed;

provide a storage bag that has flanges to allow a user to grasp the storage bag;

provide a storage bag that is formed from materials having different strengths so as to create an area where the storage bag will preferentially rupture and open when a tensile force is applied;

provide a storage bag that may be used as a vacuum packed storage bag;

provide a storage bag with a channel to allow air to be removed from an internal cavity using a vacuum during sealing operations;

provide a storage bag that may be easily opened yet has a strong internal cavity; and

provide a method of manufacturing a storage bag that is easy to open after it has been sealed.

These and other advantages may be realized by reference to the remaining portions of the specification, claims, and abstract.

### Brief Description of One Embodiment of the Present Invention

In one embodiment, a storage bag is disclosed. The storage bag includes a pair of outer sheets and an inner sheet. The outer sheets are coupled by three seams. The storage bag has a cavity between the outer sheets and an opening. The inner sheet is mounted between portions of the outer sheets near the opening. The third sheet extends across the outer sheets between a pair of seams. The inner sheet has three layers that are coupled to each other. A first layer is coupled to one of the outer sheets by another seam and a third layer is adapted to be heat bonded to the other outer sheet. A weak bond area is formed between the third layer and the outer sheet. The weak bond allows the storage bag to be easily opened.

In another embodiment, a storage bag is disclosed. The storage bag includes a first, second, third and fourth edge. A first sheet has a first side and a second side. A second sheet has a third side and a fourth side and at least a portion of the first and second sheets are strongly bonded at the first, second and third edges. The storage bag has a cavity between the first and second sheets and an opening located between the first and second sheets proximate the fourth edge. A third sheet has a fifth side and a sixth side. The third sheet is mounted between a portion of the first and second sheets proximate the opening. The third sheet extends across the first and second sheets between the first and second edges. At least a portion of the second side is strongly bonded to the fifth side. The third sheet has a first layer, a second layer and a third layer that are coupled to each other. The second layer is located between the first and third layers. The third layer of the sixth side is adapted to be weakly bonded to the third side.

In an additional embodiment, a method of manufacturing a storage bag is disclosed. The method includes providing a first sheet having a first side and a second side. The first sheet has a first height and a first width. A second sheet is provided having a third side and a fourth side. The fourth side is formed from a weak material. The second sheet has a second height and a second width. The second height of the second sheet is less than the first height of the first sheet and the second width of the second sheet is substantially the same as the first width of the first sheet. The first sheet is positioned so that the second side abuts the third side and the second sheet traverses the first width of the first sheet. The second side is bonded to the third side across the first width of the first sheet. A third sheet is provided having a fifth side and a sixth side. The third sheet has substantially the same first height and first width. The third sheet is positioned so that the fifth side abuts the fourth side and the second side where the second sheet does not cover the first sheet. The fifth side is bonded to the fourth side and the second side along a periphery of the bag thereby forming a cavity therein. The bonds between the fifth side and the second side are strong bonds. A user is allowed to create a weak bond between the fourth side and the fifth side thereby closing the storage bag.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a plan view of one embodiment of the storage bag of the present invention.

FIG. 2 is substantially an isometric view of components of the storage bag of the present invention.

FIG. 3 is substantially a schematic view of a cross-section of the storage bag of the present invention after it has been sealed.

FIG. 4 is substantially a schematic view of a cross-section of the storage bag of the present invention after the seal has been broken and the bag opened.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

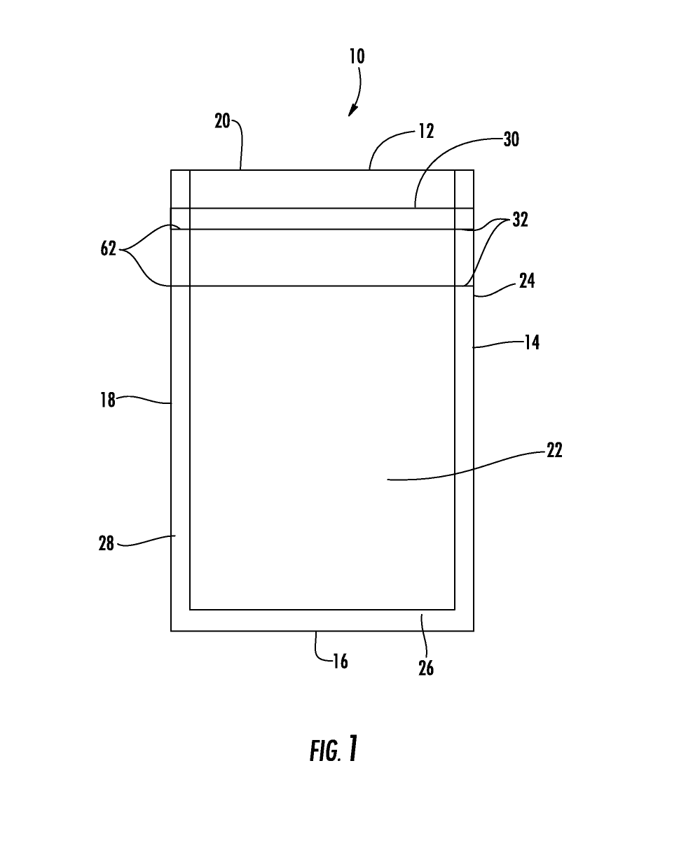

The present invention comprises a storage bag, generally indicated by reference number 10. As seen in FIG. 1, storage bag 10 comprises a first edge 12, second edge 14, third edge 16 and the fourth edge 18. Storage bag 10 has a height that is determined by the distance between first edge 12 and third edge 16 and a width that is determined by the distance between second edge 14 and fourth edge 18.

First edge 12 and third edge 16 are spaced apart, parallel and diametrically opposed. Second edge 14 and fourth edge 18 are spaced apart, parallel and diametrically opposed. First edge 12 and third edge 16 are perpendicular to second edge 14 and fourth edge 18, respectively. Storage bag 10 shown in the figures is rectangular, however, it is recognized that storage bag 10 may be made in a large variety of shapes, such as square or circular.

An opening 20 is provided along first edge 12 of storage bag 10 for allowing access to an internal cavity 22. Storage bag 10 comprises seams 24, 26 and 28 that are adjacent to second edge 14, third edge 16 and fourth edge 18, respectively. As shall be discussed in more detail below, seems 24, 26 and 28 are formed by bonding layers of material together. Seams 24 and 28 are spaced apart by the width of storage bag 10 and are generally parallel. Seam 26 is perpendicular to seams 24 and 28. In an embodiment where storage bag 10 is rounded, circular or oval shaped only one continuous seam such as seam 16 would extend around a portion of the outer circumferential edge of the storage bag.

Storage bag 10 can be formed from materials that are at least partially transparent to allow a user to view the contents of internal cavity 22.

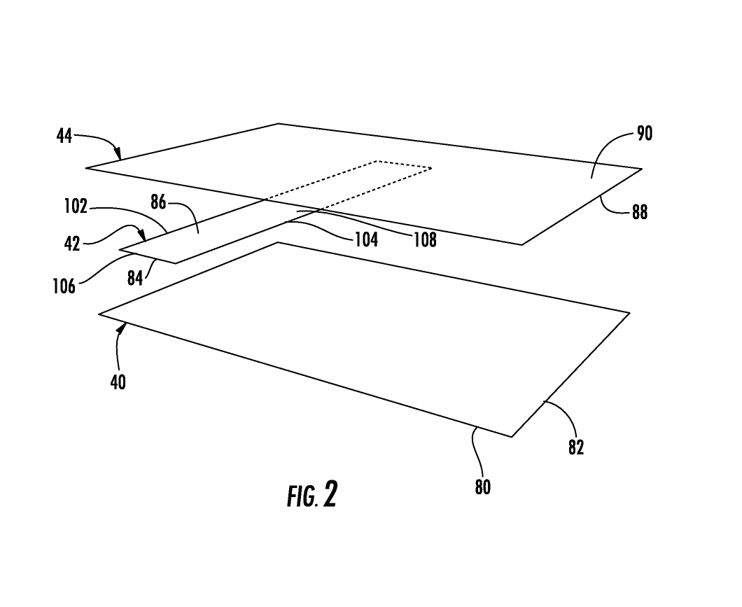

With additional reference to FIG. 2, storage bag 10 of the present invention comprises three generally planar rectangular shaped sheets, a first outer sheet 40, a second inner sheet 42 and third outer sheet 44. Sheets 40 and 44 are generally the same size. Sheets 40 and 44 are juxtaposed to each other. Sheet 42 has the same width as sheets 40 and 44; however, the length of sheet 42 is shorter compared to the length of sheets 40 and 44. Sheet 42 is located between sheets 40 and 44.

First sheet 40 comprises a first side or surface 80 and a second side or surface 82. First side 80 forms one exterior surface of storage bag 10 and second side 82 forms one interior surface that defines internal cavity 22.

Second sheet 42 comprises a third side 84, a fourth side 86 and edges 102, 104, 106 and 108. Edges 102 and 104 are spaced apart, parallel and diametrically opposed. Edges 106 and 108 are spaced apart, parallel and diametrically opposed. Edges 102 and 104 are perpendicular to edges 106 and 108, respectively.

Third side 84 is bonded to second side 82 of first sheet 40 along second edge 14 and edge 108. Third side 84 is bonded to second side 82 of first sheet 40 along fourth edge 18 and edge 106. Third side 84 of second sheet 42 is also bonded to second side 82 of first sheet 40 along another seam 30 (see FIG. 1).

Seam 30 is parallel to edges 12 and 102. Seam 30 is perpendicular to edges 14 and 18. Edge 102 extends parallel to edge 12 and faces towards opening 20. Edge 104 extends parallel to edge 12 and faces towards internal cavity 22.

In one embodiment of the present invention, the height of second sheet 42 is substantially smaller than the height of first sheet 40 and second sheet 42. Second sheet 42 is positioned generally parallel to and slightly inward of first edge 12 and opening 20 (see FIG. 1).

Third sheet 44 comprises a fifth side 88 and a sixth side 90. Fifth side 88 is bonded to side 82 of first sheet 40 along second edge 14 to form seam 24, along third edge 16 to form seam 26 and along fourth edge 18 to form seam 28.

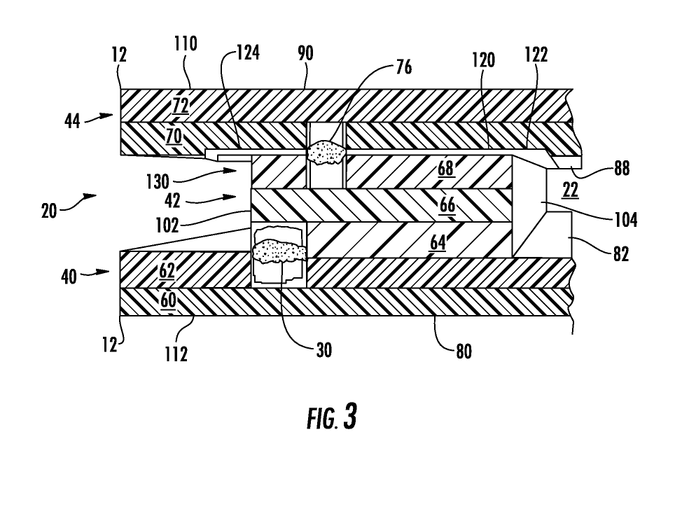

Turning to FIG. 3, first sheet 40 can comprise a plurality of generally planar parallel layers, such as layers 60 and 62. Layer 60 can comprise a material, such as nylon, that provides suitable structural properties and barrier qualities. Layer 62 can be formed from a material, such as low density polyethylene, that can be bonded to second sheet 42 and third sheet 44. Layers 60 and 62 can be bonded together.

Second sheet 42 can include a plurality of generally parallel planar shaped layers, such as first layer 64, second layer 66 and third layer 68. Layers 64, 66 and 68 can be bonded together. First layer 64 can be formed from a low density polyethylene material that can be bonded to layer 62.

When storage bag 10 is manufactured, second sheet 42 is positioned on first sheet 40 and heat is applied by a tool (not shown) to the two sheets along edge 102 between edges 106 and 108. This causes layer 62 to weld, partially melt or fuse to layer 64 forming seam 30. Seam 30 is located adjacent to opening 20. This provides for first sheet 40 to be securely attached to second sheet 42 across the width of storage bag 10.

Second layer 66 of second sheet 42 can be formed from a high density polyethylene material that provides appropriate structural properties. The third layer 68 of second sheet 42 can be formed from a material or mixture of materials that provide a weak bond to other layers. Third layer 68 can provide a weak bond to third sheet 44 or second layer 66. In one embodiment, third layer 68 can be formed from a material such as sodium ionomer which is available from DuPont under the trade name Surlyn. Other suitable materials can be used.

Third sheet 44 can comprise generally parallel planar layer 70 and layer 72. Layers 70 and 72 can be bonded together. Layer 70 can be formed from a low density polyethylene material. Layer 70 is embossed with a pattern of several channels 120 on side 88 that allows air to be evacuated from within internal cavity 22 during the sealing operation.

Channels 120 have a proximal end 122 that is open to internal cavity 22 and a distal end 124 that opens to opening 20. Proximal end 122 is located near edge 104 of sheet 42 and distal end 124 is located near edge 102 of sheet 42.

When a vacuum is applied to storage bag 10 at opening 20, air is drawn from internal cavity 22 into proximal end 122, through channel 120 and distal end 124 into opening 20. Layer 72 can be a material that provides sufficient structural strength and barrier qualities, such as nylon.

A pair of generally parallel spaced apart lips or flanges 110 and 112 form a portion of edge 12 and define opening 20. Opening 20 is defined between flanges 110 and 112. Flange 110 is a portion of third sheet 44 that extends perpendicularly from edge 102 towards edge 12. Flange 112 is a portion of first sheet 40 that extends perpendicularly from edge 102 towards edge 12.

When storage bag 10 is manufactured, layer 70 is bonded to layer 62 of first sheet 40 along second edge 14 forming seam 24, third edge 16 forming seam 26 and fourth edge 18 forming seam 28. Layer 70 and layer 62 define internal cavity 22 between sides 82 and 88.

In one embodiment of the present invention, the bonding is accomplished by applying heat and pressure in those areas. However, layer 70 is not bonded to first sheet 40 across first edge 12 or opening 20 (see FIG. 1) or to third layer 68 of second sheet 42 during the manufacturing process. This provides a passage between layers 68 and 70 through which a user may place material into cavity 22.

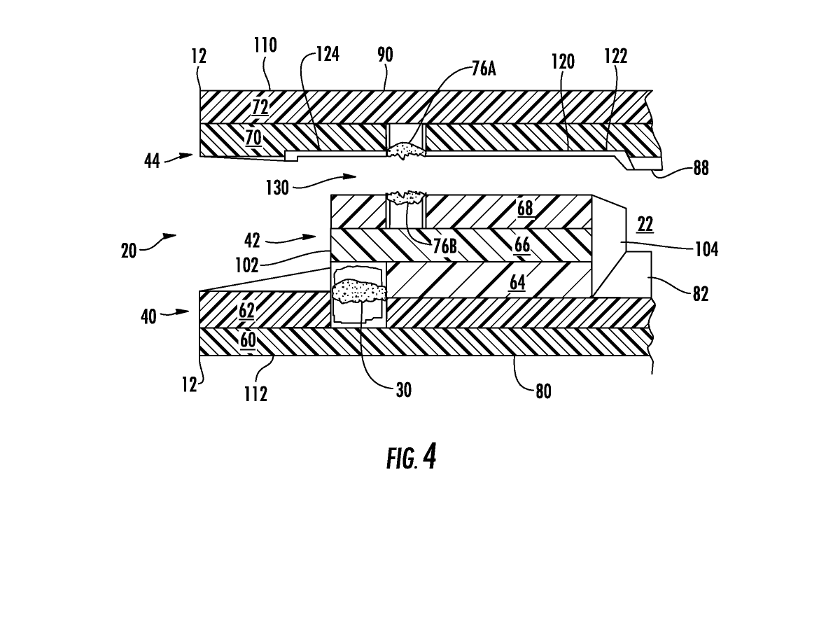

With reference now to FIGS. 3 and 4, during use, a user would open storage bag 10 at opening 20 by grasping flanges 110 and 112 and pulling them apart from each other. The user can then insert material through a passageway 130 formed between second sheet 42 and third sheet 44.

After material is placed within internal cavity 22, the user may apply a vacuum device (not shown) at opening 20 to remove air that is in interior cavity 22. The vacuum causes air to be drawn from internal cavity 22 into proximal end 122, through channel 120 and distal end 124 into opening 20.

Embossed channels 120 allow air to be removed from interior cavity 22. The user may then apply heat to storage bag 10 using a tool (not shown) to bond, melt or fuse third layer 68 of second sheet 42 and layer 70 of third sheet 44 forming a weak bond area or seam 76 (FIG. 3). Seam 76 extends at least partially into layers 68 and 70 between edges 14 and 18. Seam 76 is parallel with edge 102 and is spaced slightly away from edge 102. Bond area or seam 76 requires a lower force to break the bond area 76 than bond 30 or any other bonds or seams created between the other layers of storage bag 10.

At a later time, the user may wish to open storage bag 10 to obtain the contents or materials stored therein within interior cavity 22. The user can grasp flanges 110 and 112 and manually pull them apart from each other. Third layer 68 provides a weak bond or seam 76 to layers 66 and 70 that has a low tensile or breaking strength. The bonds to layers in storage bag 10 other than third layer 68 have a higher tensile or breaking strength and are stronger.

Because third layer 68 of second sheet 42 comprises a material that provides a weak bond, the user may more easily open bag 10 to provide access to the materials stored in interior cavity 22. It is not necessary for the user to use a tool such as a knife or scissors to cut storage bag 10 open.

The user can use manual force between first sheet 40 and third sheet 44 at opening 20. This creates a tensile stress in bonded area or seam 76 and causes second sheet 42 and third sheet 44 to rupture, peel and separate along bonded area or seam 76 instead of separating at any other seams or bonds. Bonded area or seam 76 ruptures to form broken bond areas 76A and 76B, Bonds or seams other than bond or seam 76 require a larger magnitude of force to cause a break or rupture in. More specifically, the applied manual force causes weak third layer 68 to preferentially rupture along bonded area or seam 76 creating broken bond areas 76A and 76B and opening passageway 130.

In one embodiment, storage bag 10 may be reused again by applying heat between second sheet 42 and third sheet 44 to reseal storage bag 10.

Storage bag 10 can be manufactured using a variety of processes and methods. In one embodiment method, sheets 40, 42 and 44 are dispensed from rolls of material. Second sheet 42 is positioned on first sheet 40 and heat is applied at seam 30. This bonds second sheet 42 to first sheet 40. Third sheet 44 is then positioned over first sheet 40 and second sheet 42. Heat is then applied to edge seams 24, 26 and 28. This bonds sheets 40, 42 and 44 together and forms interior cavity 22.

In some areas of storage bag 10, weak bonds 32 result from the overlapping areas of second sheet 42 and third sheet 44, specifically along edges 14 and 18. Weak bonds 32 do not significantly weaken storage bag 10 because there are strong bonds provided by seams 24 and 28 adjacent to weak bonds 32.

After first sheet 40, second sheet 42 and third sheet 44 are bonded together, a trimming machine (not shown) can cut storage bag 10 from the rolls of material. In this manner, storage bag 10 can be efficiently manufactured quickly in large quantities.

There are many other methods and processes by which storage bag 10 of the present invention may be manufactured. For example, in other embodiments, sheets 40, 42 and 44 can be bonded together using ultrasonic welding or adhesives.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A storage bag comprising:
(A) a first sheet;
(B) a second sheet coupled to the first sheet by first, second and third seams, the storage bag having a cavity between the first and second sheets;
(C) the storage bag having an opening located between the first and second sheets;
(D) a third sheet disposed between a portion of the first and second sheets proximate the opening, the third sheet extending across the first and second sheets between the first and second seams; and
(E) the third sheet having a first layer, a second layer and a third layer that are coupled to each other, the second layer located between the first and third layers, the first layer coupled to the first sheet by a fourth seam and the third layer adapted to be heat bonded to the second sheet.

2. The storage bag of claim 1, wherein a weak bonded area is located between the third layer and the second sheet, the weak bonded area being breakable by a manually applied force.

3. The storage bag of claim 1, wherein at least one channel is defined in the second sheet.

4. The storage bag of claim 3, wherein the channel extends between the opening and the cavity.

5. The storage bag of claim 1, wherein the third layer comprises an ionomer material.

6. The storage bag of claim 1, wherein the first layer comprises a low density polyethylene material.

7. The storage bag of claim 1, wherein the second layer comprises a high density polyethylene material.

8. A storage bag comprising:
(A) a first, second, third and fourth edge;
(B) a first sheet having a first side and a second side;
(C) a second sheet having a third side and a fourth side, at least a portion of the first and second sheets strongly bonded at the first, second and third edges;
(D) the storage bag having a cavity between the first and second sheets and an opening located between the first and second sheets proximate the fourth edge;
(E) a third sheet having a fifth side and a sixth side, the third sheet mounted between a portion of the first and second sheets proximate the opening, the third sheet extending across the first and second sheets between the first and second edges;
(F) at least a portion of the second side strongly bonded to the fifth side; and
(G) the third sheet having a first layer, a second layer and a third layer that are coupled to each other, the second layer located between the first and third layers, the third layer of the sixth side adapted to be weakly bonded to the third side.

9. The storage bag of claim 8, wherein a weak bonded area is located between the third side and the sixth side, the weak bonded area being breakable by a manually applied force.

10. The storage bag of claim 8, wherein at least one channel is defined in the third side.

11. The storage bag of claim 10, wherein the channel extends between the opening and the cavity.

12. The storage bag of claim 8, wherein the third layer comprises an ionomer material.

13. The storage bag of claim 8, wherein the first layer comprises a low density polyethylene material.

14. The storage bag of claim 8, wherein the second layer comprises a high density polyethylene material.

15. A method of manufacturing a storage bag, comprising, not all necessarily in the order shown:
(A) providing a first sheet having a first side and a second side, the first sheet having a first height and a first width;
(B) providing a second sheet having a third side and a fourth side, the second sheet having a second height and a second width, the second height of the second sheet being less than the first height of the first sheet and the second width of the second sheet being substantially the same as the first width of the first sheet;
(C) positioning the first sheet so that the second side abuts the third side and the second sheet traverses the first width of the first sheet;
(D) bonding the second side to the third side across the first width of the first sheet;
(E) providing a third sheet having a fifth side and a sixth side, the third sheet having substantially the same first height and first width;
(F) positioning the third sheet so that the fifth side abuts the fourth side and the second side where the second sheet does not cover the first sheet;
(G) bonding the fifth side to the fourth side and the second side along a periphery of the bag thereby forming a cavity therein, wherein the bonds between the fifth side and the second side are strong bonds; and
(H) allowing a user to create a weak bond capable of being ruptured by a manually applied force between the fourth side and the fifth side thereby closing the storage bag.

16. The method of manufacturing of claim 15, further comprising allowing the user to break the weak bond and open the bag.

17. A storage bag comprising:
(A) a first sheet;
(B) a second sheet coupled to the first sheet by at least one seam, the storage bag having a cavity between the first and second sheets;
(C) the storage bag having an opening located between the first and second sheets;
(D) a third sheet disposed between a portion of the first and second sheets proximate the opening, the third sheet extending substantially across the first and second sheets; and
(E) the third sheet having a first layer, a second layer and a third layer that are coupled to each other, the second layer located between the first and third layers, the first layer coupled to the first sheet by a second seam and the third layer adapted to be heat bonded to the second sheet.

18. The storage bag of claim 17, wherein a weak bonded area is located between the third layer and the second sheet, the weak bonded area being breakable by a manually applied force.

19. The storage bag of claim 17, wherein at least one channel is defined in the second sheet.
